(19) United States
(12) Patent Application Publication
(10) Pub. No.: US 2014/0266123 A1
(43) Pub. Date: Sep. 18, 2014

(54) TRUNCATED RAMP WAVEFORMS IN SWITCHING REGULATORS

(71) Applicant: QUALCOMM INCORPORATED, San Diego, CA (US)

(72) Inventor: William E. Rader, San Diego, CA (US)

(73) Assignee: QUALCOMM INCORPORATED, San Diego, CA (US)

(21) Appl. No.: 13/800,762

(22) Filed: Mar. 13, 2013

(51) Int. Cl. G05F 1/10

(52) U.S. Cl. CPC G05F 1/10
USPC 323/288

(57) ABSTRACT

The present disclosure includes systems and methods using truncated ramp signal in switching regulators. In one embodiment, a switching regulator includes a truncated ramp generator to produce a truncated ramp signal comprising a ramp component and a constant component. A comparator receives the truncated ramp signal and a first signal, and in accordance therewith, produces a modulation signal. The first signal is based on an output voltage or an output current, and the first signal intersects the constant component of the truncated ramp signal in response to a change in the output voltage or output current, and in accordance therewith, the first switching transistor changes state.

### BACKGROUND

The present invention relates to switching regulators, and in particular, to systems and methods using truncated ramps in a switching regulator.

Switching regulators are used in a wide variety of electronic applications. One common application of a switching regulator is to generate a power supply voltage that supplies a regulated voltage to one or more integrated circuits (ICs). FIG. 1 illustrates a switching regulator architecture. In this example, switching regulator 100 includes a PMOS transistor Tp 150, NMOS transistor Tn 151, inductor L1 152, capacitor C1 153, controller 120, voltage feedback circuit 121 and/or current feedback circuit 122. Switching regulator 100 provides a regulated voltage Vout to a load (e.g., a power supply input of an IC), which is illustrated here as Rload.

Switching regulator 100 turns transistors Tn and Tp on and off in a controlled manner to transfer power from an input source (e.g., Vin) to the load and maintain a desired output voltage and/or current. Switching regulator 100 may sense Vout using voltage feedback circuit 121 and/or an output current using current feedback circuit 122. Controller 120 receives the voltage and/or current feedback signals and generates control signals HS and LS to turn transistors Tp and Tn on and off to maintain controlled output voltage or current.

Ramp signals are sometimes used in switching regulators to control the timing of control signals HS and LS. FIG. 2 illustrates graph 201 showing a typical triangle waveform 210 and an error signal 211. Triangle waveforms are one example of a ramp signal. Error signal 211 may be derived from a sensed output voltage or current that has been compared to a known reference value. In this illustrative example, when the rising edge of the triangle waveform 210 crosses the error signal 211 (at 250) the output transistors will change state (e.g., Tp turns off and Tn turns on).

Transient response is a term that describes a circuit's ability to respond to a change from steady state. In the context of switching regulators, transient response may refer to the switching regulators ability to respond to a fast change in the load current, for example. One problem with traditional switching regulators is related to the inability of typical controllers to respond to changes in the output between cycles of a ramp signal. For example, if the current into the load increases at 251 after the leading edge of triangle wave 210 crosses error signal 211, the system may not be able to respond until the next cycle of the triangle wave (e.g., at 252). As illustrated in FIG. 2, the error signal may deviate significantly from a steady state value during this period. Deviations in error signal 211 may correspond to significant deviations in the output voltage Vout and/or output current. Under such conditions, circuits receiving power from the switching regulator may not operate properly.

### SUMMARY

The present disclosure includes systems and methods that include truncated ramp in a switching regulator. In one embodiment, the present disclosure includes a circuit comprising a first switching transistor having an input terminal to receive an input voltage and an output terminal coupled to an output node, a truncated ramp generator to produce a truncated ramp signal comprising a ramp component and a constant component, a comparator to receive the truncated ramp signal and a first signal, and in accordance therewith, produce a modulation signal, wherein the first signal is based on an output voltage or an output current, and wherein the first signal intersects the constant component of the truncated ramp signal in response to a change in the output voltage or output current, and in accordance therewith, the first switching transistor changes state.

In one embodiment, the first signal is an error signal, the circuit further comprising an error amplifier having an input coupled to the output node to produce the error signal and an output coupled to an input of the comparator.

In one embodiment, the error amplifier is configured with a bandwidth so that the error signal intersects the constant component after an intersection of the error signal and the ramp component.

In one embodiment, the truncated ramp generator comprises a ramp generator to produce a ramp signal and a sample and hold circuit to receive the ramp signal and produce the truncated ramp signal.

In one embodiment, the truncated ramp generator comprises a delay circuit having an input to receive a switching signal and an output to produce a delayed switching signal, wherein the delayed switching signal produces a transition from the ramp component to the constant component.

In one embodiment, the switching signal is the modulation signal.

In one embodiment, the delay circuit is programmable.

In one embodiment, truncated ramp generator comprises an amplifier having an input coupled to receive a ramp signal, a capacitor, and a variable impedance having a first terminal coupled to an output of the amplifier, a second terminal coupled to the capacitor, and at least one control terminal couple to receive the ramp signal, and wherein the variable impedance is in a low impedance state when the magnitude of the ramp signal is below a first value, and the variable impedance is in a high impedance state when the magnitude of the ramp waveform is above the first value.

In one embodiment, the ramp truncation circuit comprises a comparator having an input coupled to receive a ramp signal, a switch having a control terminal coupled to an output of the comparator and an input terminal coupled to receive the ramp signal, and a capacitor coupled to a second terminal of the switch.

In one embodiment, the truncated ramp signal further comprises a second constant component.

In one embodiment, the truncated ramp signal further comprises a step.

In one embodiment, the constant component sets a minimum value of the truncated ramp signal.

In one embodiment, the constant component sets a maximum value of the truncated ramp signal.

In one embodiment, the truncated ramp signal is a truncated triangle waveform.

In one embodiment, the truncated ramp signal is a truncated sawtooth waveform.

In one embodiment, the constant component is programmable.

In one embodiment, the truncated ramp generator switches from a non-truncated ramp signal to a truncated ramp signal when a steady state output voltage is reached.

In one embodiment, the error signal increases in response to an increase in load current, and wherein the error signal intersects the constant component, and in accordance therewith, turns on the switching transistor to produce more current into the load.

In one embodiment, the error signal decreases in response to a decrease in load current, and wherein the error signal intersects the constant component, and in accordance therewith, turns off the switching transistor to reduce the current into the load.

In one embodiment, the present disclosure includes a method comprising receiving an input voltage on an input terminal of a first switching transistor, the switching transistor having an output terminal coupled to a output node, generating a truncated ramp signal having a ramp component and a constant component, and comparing the truncated ramp signal and a first signal, and in accordance therewith, produce a modulation signal, wherein the first signal is based on an output voltage or an output current, and wherein the first signal intersects the constant component of the truncated ramp signal in response to a change in the output voltage or output current, and in accordance therewith, the first switching transistor changes state.

In one embodiment, the first signal is an error signal, the method further comprising amplifying the output voltage in an error amplifier to produce the error signal, wherein the error amplifier is configured with a bandwidth so that the error signal intersects the constant component after an intersection of the error signal and the ramp component.

In one embodiment, generating a truncated ramp signal comprises generating a ramp signal and truncating the ramp signal at a particular value to produce the truncated ramp signal.

In one embodiment, the method further comprises switching from a non-truncated ramp signal to a truncated ramp signal when a steady state output voltage is reached.

The following detailed description and accompanying drawings provide a better understanding of the nature and advantages of the present disclosure.

### BRIEF DESCRIPTION OF THE DRAWINGS

FIG. 1 illustrates a switching regulator architecture.

FIG. 2 illustrates graph showing a typical triangle waveform and an error signal.

FIG. 3 illustrates an example switching regulator according to an embodiment of this disclosure.

FIG. 4 illustrates truncated ramp signals according to particular embodiments.

FIG. 5 illustrates a switching regulator according to another embodiment.

FIG. 6A-B illustrate waveforms for the example signals according to different embodiments.

FIG. 7 illustrates ramp truncation for another switching regulator topology.

FIG. 8 illustrates a truncated triangle waveform from switching regulator.

FIG. 9 illustrates a sample and hold circuit according to one embodiment.

FIG. 10 illustrates a sample and hold circuit that may be used in triangle wave generator according to one embodiment.

FIG. 11 illustrates a truncation circuit according to another embodiment.

### DETAILED DESCRIPTION

The present disclosure pertains to switching regulators. In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

FIG. 3 illustrates an example switching regulator according to an embodiment of this disclosure. Switching regulator 300 includes a PMOS transistor Tp 350, NMOS transistor Tn 351, inductor L1 352, capacitor C1 353, and load illustrated by Rload 354. One terminal of Tp receives input voltage Vin and the other terminal of Tp is coupled to switching node having a voltage Vsw. One terminal of Tn is coupled to the switching node and the other terminal of Tn is coupled to ground. Tn and Tp act as switches to selectively couple nodes in the circuit together. While Tp is a PMOS transistor and Tn is an NMOS transistor in this example, it is to be understood that other switch structures and arrangements could be used. The example switching regulator architecture shown here is just one of many switching topologies that may use the techniques described herein.

Drivers 301 and 302 turn Tp and Tn on and off. When Tp is on, Tn is off, and Vsw is equal to Vin. In this state, the ac voltage across the inductor is Vin-Vout, and the inductor current I_{L} increases. For a buck converter architecture shown in this example, Vin is greater than Vout (Vin>Vout). When Tn is on, Tp is off, and Vsw is equal to ground. In this state, the ac voltage across the inductor is −Vout, and the inductor current I_{L} decreases. The inductor current into the output load generates an output voltage Vout. In this example, feedback operates to maintain the output voltage at a predetermined voltage. In a voltage feedback case, a periodic (e.g., clock based) truncated ramp is compared against a signal related to the output voltage. In other embodiments, current may be used as a feedback parameter (e.g., current control mode) using a current sense circuit 320, for example. In this case, the truncated ramp is further based on an output current. Accordingly, embodiments of the disclosure may include switching regulators that sense output voltage, output current, or both.

In this example, output voltage Vout is used as feedback. A feedback circuit 322 (e.g., including a resistor divider) may receive Vout and produce a feedback signal Vfb to the input of error amplifier (ea) 311. Error amplifier 311 may also receive a reference (e.g., in this case a voltage, Vref) to produce an error signal Ve.

Embodiments of this disclosure include using a truncated ramp signal to generate control signals to drive Tp and Tn, for example. In this example, switching regulator 300 further includes a truncated ramp generator 321. Truncated ramp generator 321 generates a truncated ramp signal V_{TRamp} that may be used in the feedback loop.

FIG. 4 illustrates truncated ramp signals according to particular embodiments. One example of a truncated ramp signal is a truncated triangle waveform 412 in graph 401 of FIG. 4. Truncated triangle waveform 412 includes a constant component 412a and a ramp component 412b (in this case, rising and falling ramps). A constant component of a truncated ramp may set a maximum or minimum value of a truncated ramp signal. In this example, the constant component 412a may be a constant voltage that sets a minimum value of the truncated ramp signal, for example, and the ramp component 412b may linearly increase from the constant value to a maximum value and then decrease back to the constant value. If a large current step occurs, Vout will begin to drop, which causes Ve to drop. However, constant component 412a of waveform 412 sets a minimum value on how far Vout, and thus Ve, may deviate before Ve becomes less than V_{TRamp}. In this example, when Ve falls below V_{TRamp}, Tp turns on and Tn turns off, thereby driving current to the output. In this case, a small deviation in Vout will cause Ve to cross V_{TRamp}, which allows the system to respond quickly to an increase in load current and recover faster than if an untruncated ramp signal is used as in FIG. 2. In other embodiments, the ramp may be truncated on the top, bottom, or both the top and the bottom, for example (e.g., on either side of a desired steady state value).

Graph 402 shows another truncated ramp signal 414 (V_{TRamp}) comprising horizontal components 414a and 414b (i.e., steps). Introducing a step in the truncated ramp signal may improve noise immunity. In steady state, error signal 415 (Ve) crosses V_{TRamp} at roughly the same point each cycle. In switching regulators using non-truncated ramps, noise may trigger a premature crossing, which may cause the system to switch multiple times (chatter) rather than only once. In this example, after the crossing point, step 414a in V_{TRamp} reduces the likelihood that the system will experience unwanted multiple switching. The step may be introduced after the steady state turn and/or turn off points, for example.

In one embodiment, the switching regulator may switch from a non-truncated ramp signal as shown in graph 201 in FIG. 2 to a truncated ramp signal such as the one shown in graph 401 when the steady state output voltage is reached. When the system is first turned on, for example, it may be desirable to use the full range of the ramp to generate PWM signals across a wider range of feedback inputs. After the system reaches steady state, a truncated ramp may be generated to improve response to sudden increases in load current, for example.

Referring again to FIG. 3, the output of truncated ramp generator 321 is coupled to one input of comparator 312. The other input of comparator 312 receives error signal Ve. Comparator 312 outputs a modulation signal “PWM” to gate drive logic 310. Gate drive logic 310 comprises logic for processing “PWM” and a clock signal CLK. In this example, gate drive logic 310 is coupled to a high side driver 301 and a low side drive 302. Driver 301 produces control signal HS to turn Tp on and off, and driver 302 produces control signal LS to turn Tn on and off.

In one embodiment, truncated ramp generator 321 may include a delay circuit (not shown) having an input to receive a switching signal and an output to produce a delayed switching signal. The delayed switching signal may control a transition from the ramp component to the constant component of the truncated ramp signal. As illustrated by a specific example below, transitions of the PWM signal may be delayed and used to control truncation. In steady state, the intersection of the truncated ramp signal and a feedback signal, such as the error signal, may occur at approximately the same point in the ramp. Thus, a delayed version of the PWM signal, or another switching signal, may be used to establish an offset above or below the steady state intersection point so that large deviations in the output voltage or output current may be compensated quickly. In various embodiments, switching signals from switching nodes Vsw, PWM or nodes in the high side or low side driver paths or gate logic may be delayed to control truncation of the ramp, for example.

In one embodiment, the constant component of the truncated ramp is programmable. For instance, in some applications the intersection of the ramp with a feedback signal from the output may occur at approximately the same point in the ramp component each cycle during steady state. Accordingly, it may be desirable to configure the constant component above and/or below the intersection point to optimize response and noise performance. In some embodiments, the constant component level can be programmed. As described in an example below, a programmable delay may be used so that the transition from the ramp component to constant component may be adjusted according to the delay technique described above.

FIG. 5 illustrates a switching regulator 500 according to another embodiment. For purposes of illustration, a similar switching regulator architecture shown in FIG. 3 is used as a further example, although the concepts illustrated are applicable to other switching topologies. Switching regulator 500 includes a PMOS transistor Tp 550, NMOS transistor Tn 551, inductor L1 552, capacitor C1 553, and load illustrated by Rload 554. Tp and Tn are turned on and off by high side driver 501 and low side driver 502, respectively, which are controlled gate drive logic 510.

This example illustrates voltage feedback using feedback network circuit 520 that generates a voltage feedback signal Vfb. A first input of an error amplifier 521 receives Vfb and a second input of the error amplifier receives a reference voltage Vref. Error amplifier 521 produces an error signal Ve, which is coupled to an input of comparator 522. A second input of comparator 522 receives a truncated ramp signal. During steady state, Vfb is approximately equal to Vref, as shown in graph 601 in FIG. 6A. In actual implementations, Vfb will move up and down near Vref, which is sometimes referred to a ripple.

In this example implementation, a truncated ramp signal is generated using ramp generator circuit 523 and a sample and hold circuit (S/H) 527. Ramp generator 523 may produce a ramp signal (untruncated). The ramp signal may be truncated using S/H 527. For instance, in one state, S/H 527 may pass the input ramp signal to the output. In another state, S/H 527 may sample and hold a particular value of the ramp signal. Thus, the output of S/H 527 may increase, following the ramp signal, to some value, and then remain at a constant value for some time period thereafter. An example truncated ramp signal V_{TRamp} 612 generated by S/H 527 is illustrated in graph 602 in FIG. 6A. V_{TRamp} 612 is a sawtooth waveform including a linearly increasing ramp component 612a, a constant component 612b, and linearly decreasing ramp component 612c. Note that the decreasing ramp component is accentuated for illustrative purposes, but is typically very steep for a sawtooth waveform. Triangle ramp waveforms typically have approximately equal rising and falling ramp components. During steady state, error signal Ve 613 intersects increasing ramp component 612a at approximately the same point each cycle as shown at 650. For instance, in a 25% buck converter (e.g., Vout=Vin/4), intersection 650 occurs at 25% of V_{TRamp}. The intersection of V_{TRamp} and Ve sets the state of a PWM signal generated by comparator 522. PWM signal 614 is illustrated in graph 603 in FIG. 6A. When V_{TRamp} is below Ve, PWM signal 614 is in a low state. When V_{TRamp} increases above Ve (e.g., at intersection 650 in FIG. 6A), PWM signal 614 switches to a high state. Similarly, when the decreasing ramp component 612c falls below Ve, PWM signal 614 switches low again.

As illustrated in graph 603, when PWM signal 614 is in a high state (e.g., when V_{TRamp} is greater than Ve), low side switch Tn is on and Tp is off, and the current I_{L} in inductor 552 decreases. Likewise, when PWM signal 614 is in a low state (e.g., when V_{TRamp} is less than Ve), high side switch Tp is on and Tn is off, and the current I_{L} in inductor 552 increases.

During steady state, deviations in Ve are typically small and the truncation of ramp 612 has little or no effect. However, if the current into the load suddenly increases, the feedback voltage Vfb may deviate substantially from Vref, as illustrated at 610-611, which causes Ve to increase as shown at 613a. As shown in graph 602, Ve intersects the constant component 612b of V_{TRamp} at 652. When Ve increases above V_{TRamp}, PWM signal 614 switches low, which turns Tp on causing the inductor current I_{L} to increase. The duty cycle of PWM signal 614 is reduced as shown at 621, which causes Tp to turn on early. Thus, truncation effectively causes PWM signal 614 to respond faster to changes in the output and allow the system to quickly increase the inductor current in response to increases in load current, for example.

Truncation allows the system to respond faster to deviations in Vfb. Accordingly, particular embodiments may set the bandwidth of the feedback circuit 520 and error amplifier 521 to correspond with the truncation level used in the ramp waveform (e.g., the value of the constant component of the ramp). For example, typical error amplifiers may have a bandwidth corresponding to the full cycle of the ramp waveform. However, because truncation allows the system to respond faster to rapid deviations of the output current, for example, the feedback circuit 520 and error amplifier 521 may be configured with bandwidths sufficiently wide to allow Ve to move more quickly to intersect the constant component of the ramp in response to changes in the output of the switching regulator. Some applications may use resistor dividers for feedback circuit 520, but error amplifier 521 may be configured to produce an error signal that crosses the constant component 612b of ramp waveform 612 before the ramp is reset. For example, the error amplifier may be configured with a bandwidth so that the error signal crosses the constant component of the truncated ramp signal in response to a change in the load current after an intersection of the error signal and the ramp component and before a subsequent intersection. Accordingly, the bandwidth of the error amplifier may be greater than frequency of the ramp (the inverse of the ramp period) by a set value.

In one embodiment, the truncation level of the ramp is dynamic. For example, in one embodiment, the constant component 612b is generated as an offset from the intersection point 650 of V_{TRamp} and Ve. Referring again to FIG. 5, one embodiment may include a delay circuit 525. Delay circuit 525 has an input coupled to the output of comparator 522 to receive PWM signal 614. Delay circuit 525 may include a delay shown at 620 in FIG. 6A. An output of delay circuit 525 may be configured to activate S/H 527. Thus, when ramp generator 523 starts producing an increasing ramp component, S/H 527 passes the ramp waveform to the input of comparator 522. However, S/H 527 may hold the output at a constant value in response to a delayed signal after PWM 614 switches high (e.g., in response to V_{TRamp} crossing Ve). Thus, the truncation level may change based on where V_{TRamp} crosses Ve. Some embodiments may advantageously truncate V_{TRamp} both above and below the steady state intersection point (as described below). The ramp may be truncated some set voltage far enough above and/or below the Ve/V_{TRamp} crossover point so that noise in the system does not cause erroneous PWM switching, for example. In one embodiment, delay circuit 525 may be a programmable delay, which may be configured to optimize the truncation level based on noise performance.

The example shown in FIG. 5 also illustrates a transient control circuit 524. In some implementations it may be beneficial to ensure that truncation does not occur prematurely or at unusual times during a load transient. For instance, transient ringing may cause large deviations in an error signal. Using the delay circuit above to generate the truncation level, for example, such deviations may result in truncation being set at a level that results in undesired switching. In one embodiment, a transient control circuit 524 may be coupled to S/H 527 through logic 526. Transient control 524 receives the ramp signal and may deactivate S/H 527 until the ramp component reaches some specific level. For example, for a 25% buck converter, transient control circuit 524 may deactivate S/H 527 until the ramp reaches 25% of the ramps full range to ensure that truncation does not occur at least until that point. Transient control 524 may activate S/H 527 after that point, so that S/H 527 may respond to signals from delay circuit 525 after the ramp has increased above 25% of the ramps full range, for example. In another embodiment, transient control 524 may not allow truncation from the beginning of the period until the end of a calculated time (e.g., Vout/Vin*Tsw). Thus, transient control circuit 524 may output a high value while the ramp is below 25% of full range, for example, and then transition to a low value when the ramp is above 25%. In one embodiment, logic circuit 526 is a NOR gate with one input triggered off transient control circuit 524 and the other input is triggered off the PWM signal. Accordingly, truncation may not occur until both a delayed falling edge of the PWM signal has been received and 25% of the increasing component of the ramp is reached.

FIG. 5 further shows one example embodiment using optional current feedback. In this case, current sense circuit 575 senses a current, such as current in Tp or inductor current I_{L}, which is used in generating a ramp waveform. It is to be understood that a variety of current mode control techniques could be incorporated a truncated ramp described herein.

FIG. 6B illustrates another example truncated ramp waveform V_{TRamp} 690 in graph 605. In this example, V_{TRamp} 690 is truncated on the top and bottom. V_{TRamp} 690 is a sawtooth waveform including a linearly increasing ramp component 690a, an upper constant component 690b, a lower constant component 690c, and linearly decreasing ramp component 690d. During steady state, error signal Ve 695 intersects increasing ramp component 690a at approximately the same point each cycle. This example shows a 50% buck converter (e.g., Vout=Vin/2). Thus, the intersection of Ve and V_{TRamp} is approximately centered on the ramp. Accordingly, the duty cycle of PWM signal 615 at steady state is approximately 50% as shown in graph 606 in FIG. 6B. In this example, if the current into the load suddenly increases, Ve increases to intersect the constant component 690b as described above. However, if the current into the load suddenly decreases, the feedback voltage Vfb may deviate substantially from Vref, as illustrated at 691, which causes Ve to decrease as shown at 695a. As shown in graph 605, Ve intersects the lower constant component 690c of V_{TRamp} at 653. When Ve decreases below V_{TRamp}, PWM signal 615 switches high, which turns Tn on causing the inductor current I_{L} to decrease. The duty cycle of PWM signal 615 is increased, which causes Tn to turn on early and quickly decrease the inductor current in response to decreases in load current, for example.

FIG. 7 illustrates ramp truncation for another switching regulator topology. In this example, switching regulator 700 includes a PMOS transistor Tp 750, NMOS transistor Tn 751, inductor L1 752, capacitor C1 753, and load illustrated by Rload 754. Tp and Tn are turned on and off by high side driver 701 and low side driver 702, respectively, which are coupled to an output of driver 720. In this example topology, a voltage signal from the output, Vout, is couple to a comparator 715. Another input of comparator 715 receives a truncated ramp signal, V_{TRamp}, from triangle wave generator 710. In this example, an output of comparator 715 is a PWM signal 750. PWM signal 750 is coupled to a compensation circuit 712 including two compensation capacitors and compensation resistors configured as a high pass filter and a low pass filter in series. An output of compensation circuit 712 is coupled to triangle wave generator 710. PWM signal 750 is also coupled to correction circuit 711, which includes correction resistor, Rcorr, and correction capacitor, Ccorr, configured as a low pass filter. An output of correction circuit 711 is coupled to triangle wave generator 710.

FIG. 8 illustrates a truncated triangle waveform 822 from switching regulator 700. An increase in load current may cause the switching regulator output voltage Vout 821 to drop. If the increase in load current occurs after the intersection of Vout and the falling edge of V_{TRamp}, Vout intersects the truncated portion of V_{TRamp} at 801, which turns Tp on. Accordingly, the system's ability to quickly increase current to the output is improved over the performance resulting from a full triangle waveform.

FIG. 9 illustrates a sample and hold circuit according to one embodiment. Sample and hold circuit includes a comparator 901, switch (SW1) 902, and capacitor (C1) 903. A first input of comparator 901 receives the ramp signal, Vramp, from ramp generator 904 and a second input of comparator 901 receives a reference voltage, Vref, for example. The output of comparator 901 is coupled to a control terminal of a switch 902. Vramp is also coupled to one terminal of switch 902. The other terminal of switch 902 is coupled to capacitor 903. When Vramp is less than Vref, the output of comparator 901 causes the switch to close, and Vramp is provided to capacitor 903. However, when Vramp increases to Vref, switch 902 opens, and capacitor 903 holds a value approximately equal to Vref. Therefore, capacitor 903 produces a truncated ramp, V_{TRramp}.

FIG. 10 illustrates a sample and hold circuit that may be used in triangle wave generator 710 according to one embodiment. This sample and hold circuit includes an amplifier 1001, variable impedance (Rv) 1002, and capacitor (C1) 1003. A first input of amplifier 1001 receives the ramp signal, Vramp (e.g., here, a triangle) from ramp generator 1004, and a second input of amplifier 1001 receives a correction voltage, Vcorr, from correction circuit 711, for example. An output of amplifier 1001 is coupled to a control input of variable impedance 1002 and also to an input terminal of variable impedance 1002. A second control terminal of variable impedance 1002 is coupled to a reference voltage, Vref, and an output terminal of variable impedance 1002 is coupled to capacitor 1003. Variable impedance may comprise comparator 901 and switch 902 in FIG. 9, for example. In this example, amplifier 1001 is configured to have a gain of one (1). Accordingly, the output of amplifier 1001 is Vramp-Vcorr. Variable impedance, Rv, 1002 may be in a high impedance state when the magnitude of the ramp signal is below a first value, and it may be in a low impedance state when the magnitude of the ramp signal is above the first value. In this example, starting from a peak, the ramp signal at the output of amplifier 1001 causes Rv to be in a low impedance state. Thus, the voltage on capacitor 1001 is a ramp. However, Rv clamps the triangle signal at a constant value (e.g., 7.5 mV below Vref). When the output voltage decreases below a threshold, Rv transitions into high impedance and the capacitor voltage stays constant. When the output voltage increases above the threshold, Rv transitions into low impedance and the capacitor voltage is again a ramp.

FIG. 11 illustrates a truncation circuit according to another embodiment. In this example, a ramp generator 1101 receives a clock signal CLK and produces a ramp signal to one input of a switch 1108. Ramp generator 1101 includes a switch 1102 (e.g., an MOS transistor), current source 1103, and capacitor 1104. Current I1 from current source 1103 charges capacitor 1104 causing the voltage on capacitor 1104 to increase approximately linearly. When CLK goes high, capacitor 1104 is discharged to ground. The input of switch 1108 thereby receives a ramp signal.

A PWM signal is received by a delay circuit 1105. A logic circuit 1106 receives the delayed PWM signal and a transient control signal. The output of logic circuit 1106 is coupled to the SET input of an SR latch 1107. Logic circuit 1106 ensures that latch 1107 is not set during transients. Logic circuit 1106 may be an AND gate, for example. A RESET input of latch 1107 is coupled to receive CLK, and an output Q is coupled to a control input of switch 1108. Accordingly, a delayed PWM signal sets latch 1107 and closes switch 1108 to truncated the ramp signal from ramp generator 1101. In this example, CLK resets the ramp signal and opens the switch for the next cycle of the ramp.

The above description illustrates various embodiments of the present invention along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A circuit comprising:
a first switching transistor having an input terminal to receive an input voltage and an output terminal coupled to an output node;
a truncated ramp generator to produce a truncated ramp signal comprising a ramp component and a constant component; and
a comparator to receive the truncated ramp signal and a first signal, and in accordance therewith, produce a modulation signal,
wherein the first signal is based on an output voltage, and
wherein the first signal intersects the constant component of the truncated ramp signal in response to a change in the output voltage, and in accordance therewith, the first switching transistor changes state.

2. The circuit of claim 1 wherein the first signal is an error signal, the circuit further comprising an error amplifier having an input coupled to the output node to produce the error signal and an output coupled to an input of the comparator.

3. The circuit of claim 2 wherein the error amplifier is configured with a bandwidth so that the error signal intersects the constant component after an intersection of the error signal and the ramp component.

4. The circuit of claim 1 wherein the truncated ramp generator comprises:
a ramp generator to produce a ramp signal; and
a sample and hold circuit to receive the ramp signal and produce the truncated ramp signal.

5. The circuit of claim 1 wherein the truncated ramp generator comprises a delay circuit having an input to receive a switching signal and an output to produce a delayed switching signal, wherein the delayed switching signal produces a transition from the ramp component to the constant component.

6. The circuit of claim 5 wherein the switching signal is the modulation signal.

7. The circuit of claim 5 wherein the delay circuit is programmable.

8. The circuit of claim 1, the truncated ramp generator comprising:
an amplifier having an input coupled to receive a ramp signal;
a capacitor; and
a variable impedance having a first terminal coupled to an output of the amplifier, a second terminal coupled to the capacitor, and at least one control terminal couple to receive the ramp signal; and
wherein the variable impedance is in a low impedance state when the magnitude of the ramp signal is below a first value, and the variable impedance is in a high impedance state when the magnitude of the ramp waveform is above the first value.

9. The circuit of claim 1 wherein the ramp truncation circuit comprises:
a comparator having an input coupled to receive a ramp signal;
a switch having a control terminal coupled to an output of the comparator and an input terminal coupled to receive the ramp signal; and
a capacitor coupled to a second terminal of the switch.

10. The circuit of claim 1, the truncated ramp signal further comprising a second constant component.

11. The circuit of claim 1, the truncated ramp signal further comprising a step.

12. The circuit of claim 1 wherein the constant component sets a minimum value of the truncated ramp signal.

13. The circuit of claim 1 wherein the constant component sets a maximum value of the truncated ramp signal.

14. The circuit of claim 1 wherein the truncated ramp signal is a truncated triangle waveform.

15. The circuit of claim 1 wherein the truncated ramp signal is a truncated sawtooth waveform.

16. The circuit of claim 1 wherein the constant component is programmable.

17. The circuit of claim 1 wherein the truncated ramp generator switches from a non-truncated ramp signal to a truncated ramp signal when a steady state output voltage is reached.

18. The circuit of claim 1 wherein the error signal increases in response to an increase in load current, and wherein the error signal intersects the constant component, and in accordance therewith, turns on the switching transistor to produce more current into the load.

19. The circuit of claim 1 wherein the error signal decreases in response to a decrease in load current, and wherein the error signal intersects the constant component, and in accordance therewith, turns off the switching transistor to reduce the current into the load.

20. The circuit of claim 1 wherein the truncated ramp signal is based on an output current.

21. A method comprising:
receiving an input voltage on an input terminal of a first switching transistor, the switching transistor having an output terminal coupled to a output node;
generating a truncated ramp signal having a ramp component and a constant component; and
comparing the truncated ramp signal and a first signal, and in accordance therewith, produce a modulation signal,
wherein the first signal is based on an output voltage, and
wherein the first signal intersects the constant component of the truncated ramp signal in response to a change in the output voltage, and in accordance therewith, the first switching transistor changes state.

22. The method of claim 21 wherein the first signal is an error signal, the method further comprising amplifying the output voltage in an error amplifier to produce the error signal, wherein the error amplifier is configured with a bandwidth so that the error signal intersects the constant component after an intersection of the error signal and the ramp component.

23. The method of claim 21 wherein generating a truncated ramp signal comprises:
generating a ramp signal; and
truncating the ramp signal at a particular value to produce the truncated ramp signal.

24. The method of claim 21 wherein the constant component is programmable.

25. The method of claim 21 further comprising switching from a non-truncated ramp signal to a truncated ramp signal when a steady state output voltage is reached.
